(19) United States
(12) Patent Application Publication
(10) Pub. No.: US 2011/0032718 A1
(43) Pub. Date: Feb. 10, 2011

(54) INTERSECTION-BREACHING EMERGENCY RESPONSE VEHICLE WARNING LIGHT ASSEMBLY

(76) Inventor: Curtis Bryant, Hermann, MO (US)

Correspondence Address: GALLOP, JOHNSON & NEUMAN, L.C., 101 S. HANLEY, SUITE 1600, ST. LOUIS, MO, 63105, US

(21) Appl. No.: 12/537,787

(22) Filed: Aug. 7, 2009

(51) Int. Cl. B60Q 1/50; B60Q 1/26

(52) U.S. Cl. 362/497; 362/505

(57) ABSTRACT

The present invention is an intersection-breaching emergency response vehicle warning light incorporated into the front license plate holder. The invention includes a license plate holder and two LEDs, where each LED is mounted within a light orifice such that the lens and one or more bulbs is positioned outwardly from the license plate holder housing, as well as related wiring and hardware.

### FIELD OF THE INVENTION

The present invention relates in general to an emergency response indicator, preferably for mounting on a vehicle. More particularly, the present invention relates to lights mounted on or in emergency response vehicles, such as police cars, ambulances, fire engines, and the like, including discrete emergency response vehicles.

### BACKGROUND OF THE INVENTION

An emergency response vehicle, such as a police car, ambulance, fire engine, and the like is typically equipped with attention attracting devices such as warning lights of some kind. The warning lights may include roof-mounted warning lights that span the width of the vehicle's roof outside the vehicle, above the front seats of the vehicle. The warning lights include pulsating lights, lights around which reflective surfaces rotate, or both. Additional warning lights on such a vehicle often include dashboard-mounted lights and rear window lights. If programmed to do so, some or all of the headlights, taillights and turn indicator lights pulsate when the vehicle operator turns on the roof-mounted lights and other warning lights.

The attention-attracting device, including warning lights, indicate to the public, such as other motorists and pedestrians, that the emergency response vehicle is entitled to the right of way in order to respond to some emergency. Such right of way includes, in some jurisdictions, the right to violate red lights, to fail to stop for stop signs, to fail to yield, to exceed posted speed limits, to drive the wrong way in a lane or street, or otherwise to violate the typical rules of the road. This right of way is usually necessary to expedite the emergency responder's travel to the site of the emergency. Taking such right of way, however, can create a hazard and, therefore, advance warning to other motorists is not only imperative, but required by law in many jurisdictions. The warning lights, often in combination with an audible siren, are intended to provide that advance warning to other motorists and pedestrians and to satisfy the aforementioned legal requirement, where present.

A significant percentage of emergency response vehicle traffic accidents occur during emergency operation. Many, if not most, of these crashes occur at intersections, and typically involve vehicles approaching at right angles to the emergency response vehicle's direction of travel. Often, these accidents may occur because the emergency lights on the vehicle are not visible to cross traffic at occupied intersections until after the emergency vehicle has entered the intersection.

A traffic intersection is the intersection of two or more streets, where the intersection is commonly spatially defined by the street corners or the portion of the road shared by both streets. Breaching an intersection is the entrance of a vehicle into the portion of the road shared by the intersecting streets, or when the vehicle breaks the vertical plane defined at its base by any two adjacent street corners.

Depending on the surrounding structures or other traffic, an emergency response vehicle driver travelling down a first road may not be able to see sufficiently down one or more sides of a second intersecting cross road until the driver has already breached the traffic intersection. A sufficient line of sight down the second intersecting cross road may not be fully attained until the driver's body has actually breached the intersection, by which time about half of the vehicle may be within the intersection.

Similarly, as the typical roof-mounted lights reside over the driver, and because the headlights generally face forward, in some situations the first time a motorist or pedestrian or bicyclist approaching an intersection may see a warning light on an emergency response vehicle entering the intersection from a crossroad may be as late as when the emergency response vehicle driver's body has breached the intersection, by which time as much as half of the emergency response vehicle may already be within the intersection. This problem can be especially significant when surrounding structures or traffic obstruct the view of the crossroad. This combination of problems can and does result in motor vehicle accidents. Thus there exists a pressing need in the art to alert those approaching an intersection sooner of an emergency vehicle entering the intersection from a crossroad.

Emergency lights mounted to the roofs of emergency response vehicles may work well for forward, rearward, and multidirectional warning at uncongested and unoccupied intersections. However, this arrangement is often ineffective as a multidirectional warning device at occupied intersections, particularly when large vehicles, such as minivans, sport utility vehicles, trucks, buses, and other oversized vehicles, are present at an intersection, thereby obstructing views of the lights. Oftentimes the roof of an emergency response vehicle may not be seen by cross traffic until that emergency response vehicle has cleared the visual obstruction posed by adjacent vehicles. Thus, by the time roof-mounted lights clear the obstruction of adjacent vehicles, the emergency response vehicle as well as the responder inside, have already entered the intersection.

Public safety agencies have attempted to remedy this deficiency by retrofitting or installing strobe lights into the front corner lights of their vehicles. However, this remedy has several shortcomings, including high cost of materials and labor, partial destruction of the vehicle to accommodate the retrofitting, potential warranty nullification, the need to safely and conveniently locate the associated wiring and other components, and the limitations of a single strobe light in each headlight.

Other attempted remedies include the responder manually sweeping a spotlight at cross traffic as the vehicle approaches the intersection, installing warning lights on the side view mirrors, and mounting lights on the front of the dashboard at the base of the windshield. However, while each of these remedies does offer added warning power at unoccupied intersections, due to the location of them on the lower portion of the emergency response vehicle, below the roof line, and aft or behind the emergency response vehicle's engine compartment, they do not adequately resolve the aforementioned problems associated with approaching a potentially dangerous intersection.

Yet another attempted remedy comprises the installation of push bumpers on the front of the emergency response vehicle, followed by affixing side facing warning lights aft of the pushing surface. Though a serviceable remedy, many agencies no longer utilize push bumpers because of the liability they pose, the burden of installation, cost, vehicle disfigurement, and interference with air bag deployment systems.

Yet another attempted remedy comprises a mounting bracket which utilizes the license plate screws to secure the bracket to the vehicle. Such a bracket extends outwardly from the license plate and warning lights are affixed to the bracket. This remedy, however, is ineffective as standard license plate holders are not designed to withstand the torque of wind catching appendages at high speeds, may break, afford no protection to costly warning lights during even a minor collision, may obstruct the license plate, are unsightly with exposed wiring, and the variety of license plate holder designs among the many automakers limits the universality of bracket designs.

Thus, a continuous need exists for improvements to the warning lights of the emergency response vehicle, specifically the manner in which they provide maximum advance visual warning to other motorists, bicyclists and pedestrians at an intersection.

### SUMMARY OF THE INVENTION

In accordance with the present invention there is provided an emergency response vehicle lighting arrangement that is adapted to alert stopped vehicles, moving vehicles and pedestrians that the emergency response vehicle incorporating the present invention is breaching an intersection and that the appropriate action should be taken to avoid the emergency response vehicle.

The present invention is an attention-attracting device comprising a frame for a license plate and a light display on, in, or extending from the frame. More particularly, the present invention is an intersection-breaching emergency response vehicle warning light, and additionally includes a system associated therewith. The warning light is mounted on the vehicle at what is typically the foremost portion of the vehicle: the front license plate holder. By mounting a warning light or series of lights on the front license plate holder, when the emergency response vehicle is entering an intersection from a first road, motorists approaching the intersection on a second road will see warning lights much sooner than if the lights were only roof-mounted warning lights. This feature allows the emergency response vehicle to more safely enter the intersection, as these lights give advance warning of the vehicle sooner than what was previously known in the art, and they do so without exposing the driver of the emergency response vehicle to potentially unaware oncoming traffic in the cross road.

In sum, in a particularly preferred embodiment, the present invention is a license plate holder assembly comprising a license plate holder and two light emitting diodes (LED), wherein the license plate holder comprises a front, a top, a bottom, and left and right sides, where the front, the top, the bottom, and the left and right sides define a housing, where the front further comprising a mechanism by which a license plate may be affixed thereto, and where the left and right sides each further comprising at least one light orifice, and where the housing is an at least partially concave cavity, and wherein each LED comprises a lighthead, each lighthead comprising a lens and one or more bulbs, and wherein each LED is mounted within a light orifice such that light is expelled outwardly from the housing, and wherein the lens and one or more bulbs may either be positioned via the use of spacers or other means to protrude beyond the side walls of the housing, or flush mounted with the side walls of the housing, and wherein the license plate holder assembly further comprises wiring for operatively connecting each LED to an emergency response vehicle, the wiring, including preferably a fuse, substantially contained within the housing.

Accordingly, it is an object of the present invention to warn one or more other vehicles, pedestrians, cyclists, motor cyclists, skate boarders, etc. that they are about to enter the same intersection as an emergency response vehicle.

Another object of the present invention is to provide an intersection breaching lighting arrangement that has the characteristic of illuminating the emergency response vehicle as it breaches the intersection thereby alerting a motorist, motor cyclist, cyclist, public transit, another emergency response vehicle or pedestrian deciding whether to enter the same intersection that the correct decision is to avoid entering the intersection, if possible.

Another object of the present invention is to provide improved emergency response vehicle illumination when an emergency response vehicle breaches or is about to breach a traffic intersection.

### DESCRIPTION OF THE DRAWINGS

Numerous other objects, features and advantages of the present invention should now become apparent upon a reading of the following detailed description taken in conjunction with the accompanying drawings, in which:

FIG. 1A is a rear view of a first embodiment of a license plate holder of the present invention;

FIG. 1B is a front view of the first embodiment;

FIG. 1C is a top view of the first embodiment;

FIG. 1D is a side view of the first embodiment;

FIG. 2A is a rear view of the first embodiment, with dashed lines to indicate wiring and internal features;

FIG. 2B is a front view of the first embodiment, with dashed lines to indicate wiring and internal features;

FIG. 2C is a top view of the first embodiment, with dashed lines to indicate wiring and internal features;

FIG. 2D is a side view of the first embodiment, with dashed lines to indicate wiring and internal features;

FIG. 3A is a front view of the first embodiment, with a license plate mounted thereon, this view showing an external mount of the LED;

FIG. 3B is a perspective view of the first embodiment, with a license plate mounted thereon, this view showing an external mount of the LED;

FIG. 3C is a front view of the first embodiment, with a license plate mounted thereon, this view showing an internal mount of the LED with LED lens protruding from the side wall;

FIG. 3D is a perspective view of the first embodiment, with a license plate mounted thereon, this view showing an internal mount of the LED with LED lens protruding from the side wall;

FIG. 3E is a front view of the first embodiment, with a license plate mounted thereon, this view showing an internal mount of the LED with LED lens covertly positioned flush with the side wall;

FIG. 3F is a perspective view of the first embodiment, with a license plate mounted thereon, this view showing an internal mount of the LED with LED lens covertly positioned flush with the side wall;

FIG. 4A is an exploded perspective view of a warning light suitable for use in the present invention;

FIG. 4B is an exploded side view of a suitable LED for use in the present invention, including spacers to accommodate the desired lens position;

FIG. 4C is an exploded top view of a suitable LED for use in the present invention, including spacers to accommodate the desired lens position;

FIG. 5A is a partial rear view of an embodiment of the present invention, this view showing the LED in an external mount configuration, relative to the side wall of the license plate holder.

FIG. 5B is a partial rear cutaway view of an embodiment of the present invention, this view showing the LED in an internal mount configuration, relative to the side wall of the license plate holder, with LED lens protruding from the side wall, rear spacer inserted behind the LED.

FIG. 5C is a partial rear cutaway view of an embodiment of the present invention, this view showing the LED in an internal mount configuration, relative to the side wall of the license plate holder, with LED lens flush with the side wall, rear spacer removed.

FIG. 6 is a perspective view of an embodiment of the present invention installed on an emergency vehicle;

FIG. 7 is a street intersection diagram showing an emergency response vehicle approaching a cross street;

FIG. 8 is a street intersection diagram showing an emergency response vehicle, where the license plate holder is breaching the intersection; and

FIG. 9 is a street intersection diagram showing an emergency response vehicle, where the driver and traditional roof-mounted emergency lights are breaching the intersection.

FIG. 10A is a top view of an embodiment of the present invention mounted on an emergency response vehicle, this view showing the range of angles that light from each LED may be projected outward, relative to the forward direction of travel of the emergency response vehicle.

FIG. 10B is a top view of an embodiment of the present invention mounted on another emergency response vehicle, this view showing the range of angles that light from each LED may be projected outward, relative to the forward direction of travel of the emergency response vehicle.

FIG. 10C is a top view of an embodiment of the present invention mounted on yet another emergency response vehicle, this view showing the range of angles that light from each LED may be projected outward, relative to the forward direction of travel of the emergency response vehicle.

Corresponding reference numbers indicate corresponding parts throughout the several views of the drawings.

### DETAILED DESCRIPTION OF THE INVENTION

Generally, an attention-attracting device preferably comprises a frame for a license plate and a light display on, in, or extending from the frame. The frame is preferably configured to permit mounting on or about a front surface of a front bumper of an automotive vehicle, such as an emergency response vehicle. Once the frame, having a front and back and two sides, has been mounted on the bumper, the light display is situated in front of the bumper and is lit or lightable to emit light that is visible from a vantage point on each side of the vehicle laterally ahead of the front surface of the bumper.

The present invention thus comprises a warning light or series of warning lights in or on one or more sides of the front license plate frame for a vehicle. The present invention preferably additionally comprises the wiring and other hardware associated with the warning lights as well as the hardware associated with mounting the license plate frame and a license plate. In a preferred embodiment, the frame is a license plate holder.

In a preferred embodiment, the vehicle is an emergency response vehicle that has been equipped with a warning light or series of warning lights on one or more sides of the front license plate frame of the vehicle. In another aspect, the present invention contemplates a method of operating a warning light or series of warning lights that have been mounted on one or more sides of the front license plate frame of a vehicle, as well as a method of operating a vehicle that has been equipped with a warning light or series of warning lights on one or more sides of the front license plate frame of the vehicle.

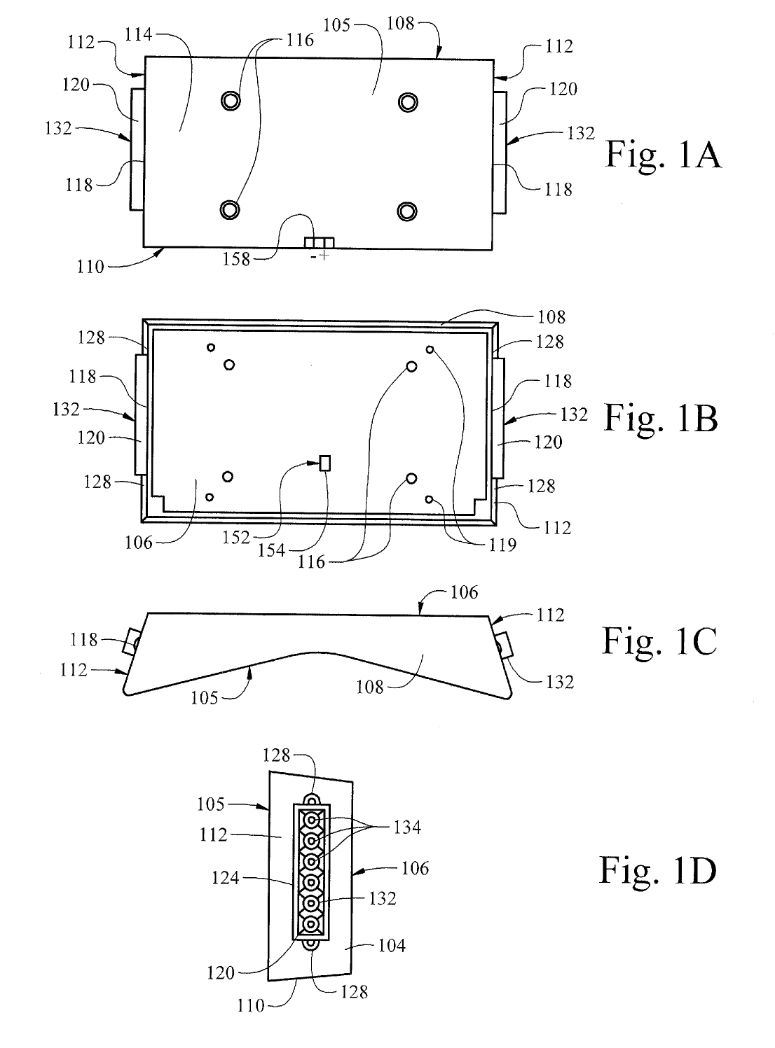

Turning now to the figures, as can be seen in FIGS. 1A, 1B, 1C and 1D, the attention-attracting device 104 of the present invention comprises a frame. In a preferred embodiment, the frame comprises left and right sides 112, the sides at least partially defining a housing 114. The frame may further comprise a front 106, a top 108, and a bottom 110, where the front, the top, the bottom, and the left and right sides 112 define the housing 114. The license plate holder 104 may optionally further comprise a back 105, where the back, when present, together with the front 106, top 108, bottom 110, and left and right sides 112 define the housing 114. The frame preferably further comprises a mechanism 116 by which a license plate may be affixed thereto, and preferably comprises a mechanism 119 by which the frame is affixed to the vehicle 102, both through any number of ways previously known to those of ordinary skill in the art. The left and right sides 112 may each further comprise at least one light orifice 118, the light orifices each being capable of accepting and having mounted therein one or more warning lights 120, where the warning light is preferably an LED. The housing 114 provides an at least partially concave cavity within which wiring 130 and various other components may be discretely and protectively housed so as to connect the warning lights 120 to the emergency response vehicle electrical system. The left and right sides 112 are preferably spaced horizontally apart from each other so as to be able to straddle a license plate 156 therebetween.

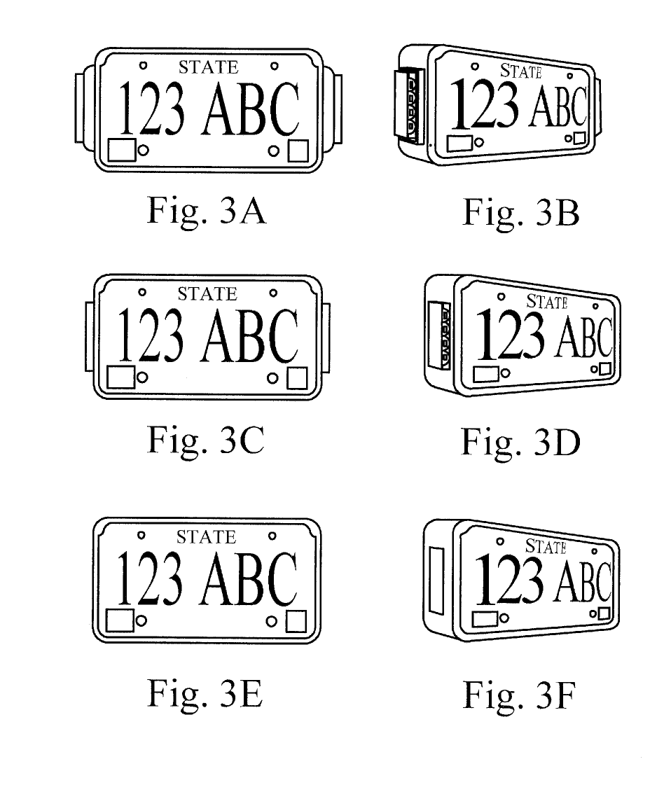

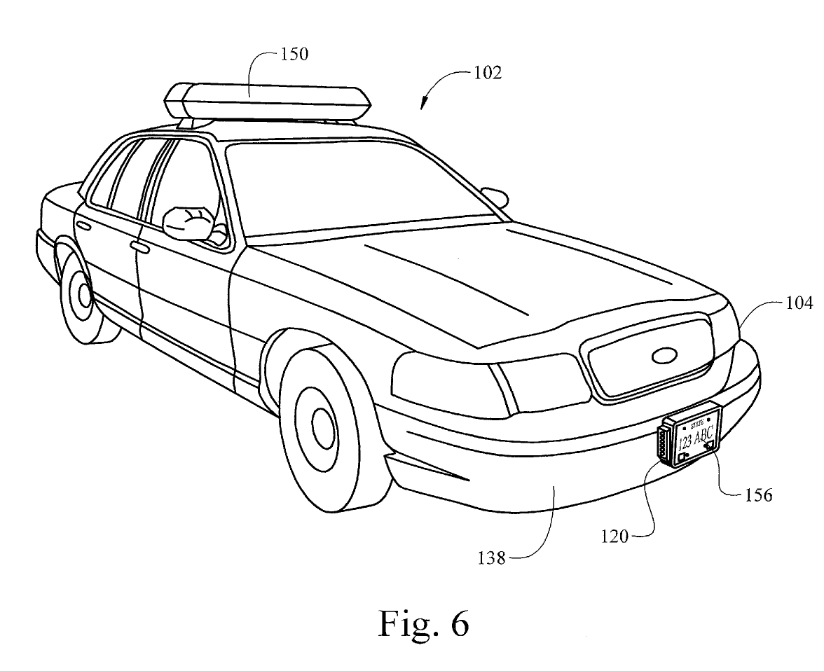

In an embodiment, from the front of an automotive vehicle 102, the present invention thus appears to be a standard motor vehicle license plate holder that has been equipped with two low profile, preferably clear plastic lenses either protruding from or flush mounted with the left and right sides, vertically. FIGS. 3A, 3B and 3C show an embodiment of the present invention with a license plate 156 mounted thereon. Further, FIG. 6 shows the attention-attracting device 104 installed on an emergency response vehicle 102.

In the preferred embodiment, the present invention measures between about 5″ and about 10″ in height, and preferably is about 7″ in height. In this preferred embodiment, the present invention measured between about 10″ and about 16″ in width, and preferably is about 13″ in width.

Many standard license plate holders in the prior art may measure between about ½″ and about 1½″ in depth. However, in the preferred embodiment, the present invention measures between about 2″ and about 3½″ in depth, and preferably is about 2⅛″ in depth. The depth of the license plate holder 104 of the present invention is such that two LEDs 120, the related wiring 130, and spacer materials 157 may be mounted vertically inside the housing 114.

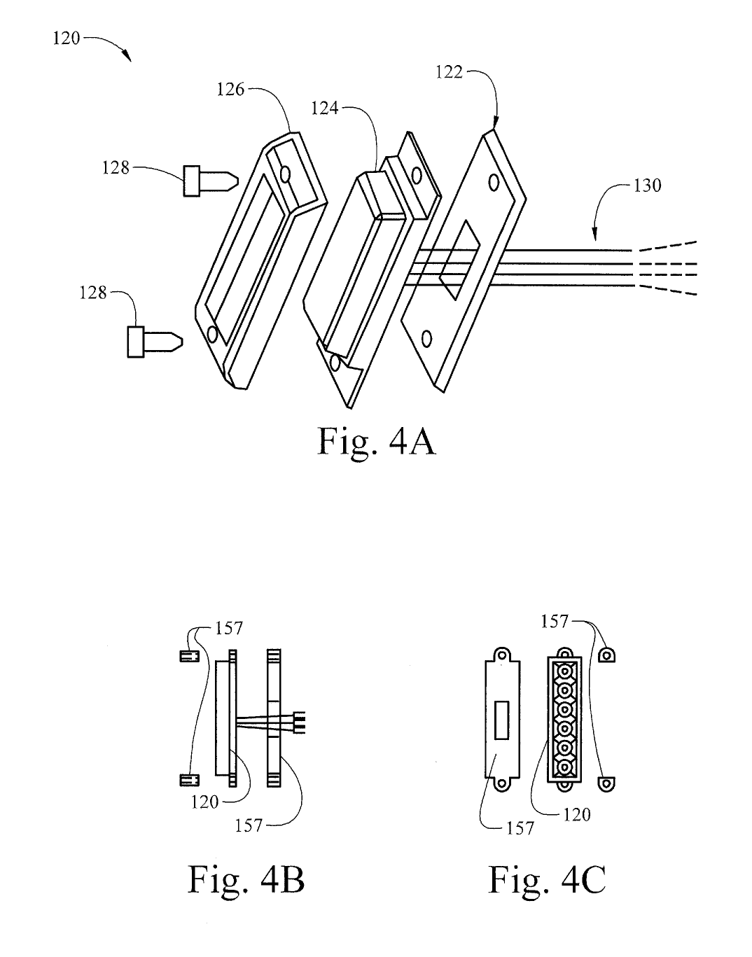

FIGS. 4A, 4B and 4C show embodiments of suitable LEDs 120 for use with the present invention. Each LED may comprise a mounting gasket 122, a lighthead 124, an optional bezel 126, screws 128 and related wiring 130. The lighthead may comprise a lens 132 and one or more bulbs 134. The LED 120 may emit light of any suitable color, such as red, amber, blue, white and green. Each LED 120 may contain a plurality of light bulbs 134, preferably four to six bulbs. In particular, FIGS. 4B and 4C show exploded views of a suitable LED for this invention, including spacers 157 for use in positioning the lens so that it either protrudes beyond the side wall 112 or is flush with the side wall 112.

Each LED 120 light may be an independent, self contained device. The controlling wiring 130 and mounting hardware are concealed inside the housing 114 such that, when the present invention is viewed from the front or when mounted on a vehicle 102, among the components of each LED 120, only the lights 134 and lenses 132 are visible.

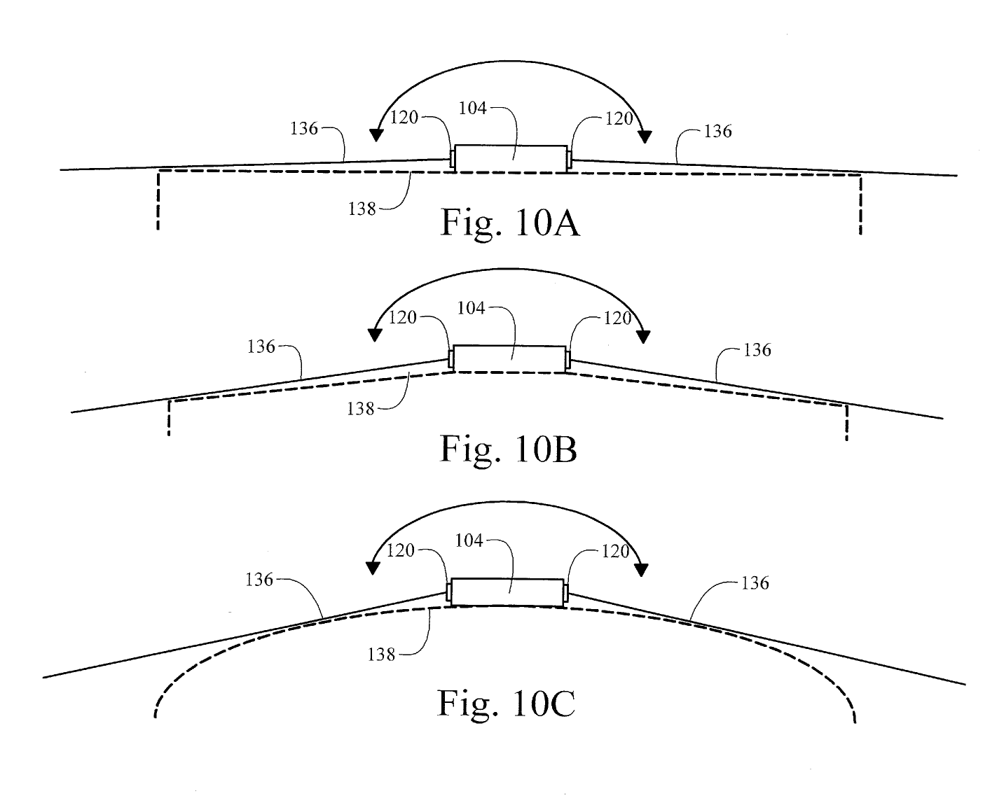

When activated, the light 136 from each LED 120 may be projected outward at an angle, relative to the forward direction of travel of the emergency response vehicle 102 of zero degrees to greater than 90 degrees, and preferably projected 60 degrees. The upper limit of the angle of light 136 projected from the LED 120 relative to the forward direction of travel of the emergency response vehicle 102 is defined by the curvature or angle of the front bumper 138, relative to the position of the LED, as can be seen further in FIGS. 10A, 10B and 10C, where the front bumper is indicated by dashed lines.

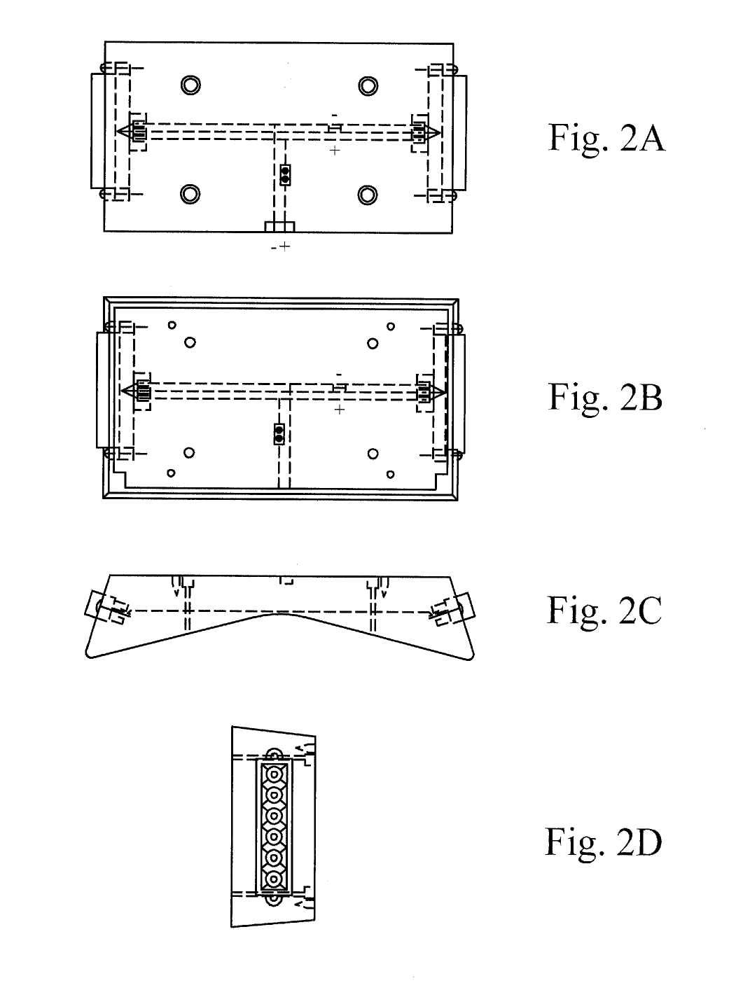

The present invention may be wired in a manner that combines the circuits of both LEDs into one fused circuit. The wiring may be hard cast inside the mold of the license plate holder, with the circuit ends terminating at the LED at one end, and at the rear or base of the license plate holder 104 at the other end. The ends of the circuit may emerge in the form of male terminals 158. The circuit fuse 154 may be accessed from the front of the present invention by removing the license plate 156, then entering a sealable compartment 152 on the front 106 that may provide access by the wiring 130 to the housing 114 and the LEDs 120. FIGS. 2A, 2B, 2C and 2D show an embodiment of the present invention, with dashed lines to indicate wiring.

As detailed above, an additional preferred embodiment, as can be seen in FIGS. 3E and 3F, which applies to use of the present invention on covert emergency response vehicles, includes an installation whereby the LEDs have been mounted so as to be of a lower profile. In an embodiment, the LEDs 120 may be mounted such that the face of the lens 132 is flush with the side wall 112, making them less visible when not illuminated. While protruding lenses expel a more visible multidirectional light and thus may be more preferred for overt emergency response vehicles, flush mounted lenses, though they expel a less multidirectional light, are less apparent to casual observers when not illuminated. The lower profile installation may be achieved by any number of methods known to those of ordinary skill in the art, including but not limited to, an orifice within the housing designed to accommodate the insertion of a spacer material 157. The spacer material 157, which is installed behind the lighthead 124 for the protruding configuration, can be removed for the flush mount configuration, thus allowing the LED 120 to set deeper within the housing. Additional spacers of varying design may be utilized to facilitate installation of the LED 120.

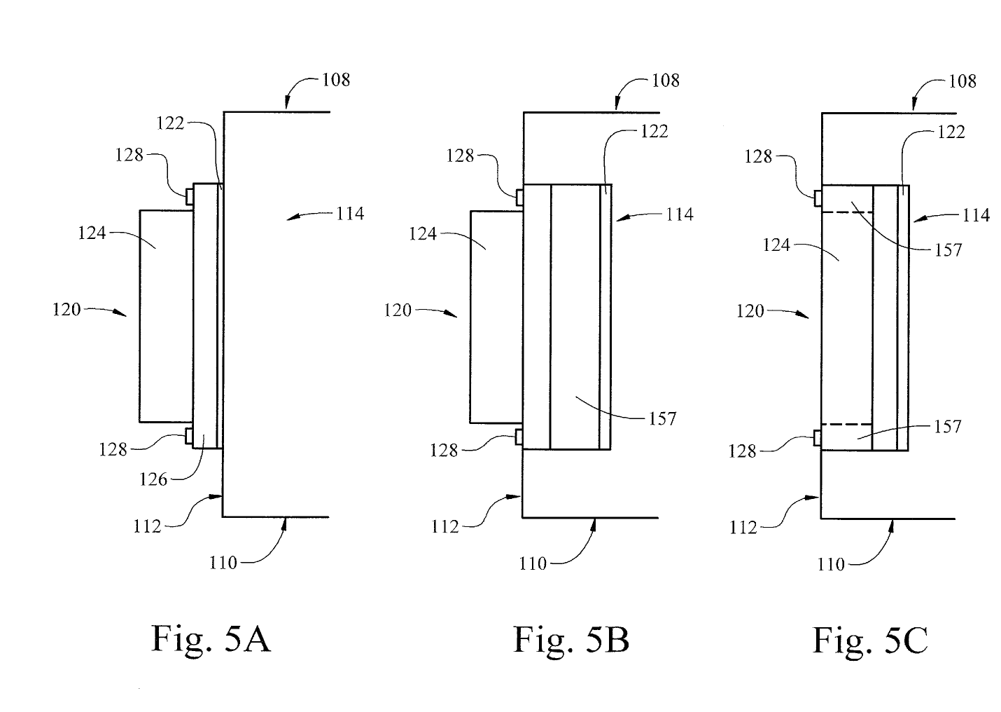

FIG. 5A shows an external mount configuration, where the LED 120 is not in a low profile configuration, relative to the side wall 112 of the license plate frame. FIG. 5B shows the LED an internal mount configuration, relative to the side wall of the license plate frame, with LED lens protruding from the side wall, rear spacer 157 inserted behind the LED lighthead 124.

FIG. 5C shows an internal mount configuration, relative to the side wall of the license plate frame, with LED lens flush with the side wall, rear spacer removed, but additional spacers 157 installed to facilitate installation of the lighthead 124. While FIG. 5A and FIG. 5B are optimal for overt vehicles, FIG. 5C is optimal for covert vehicles, due to the low profile.

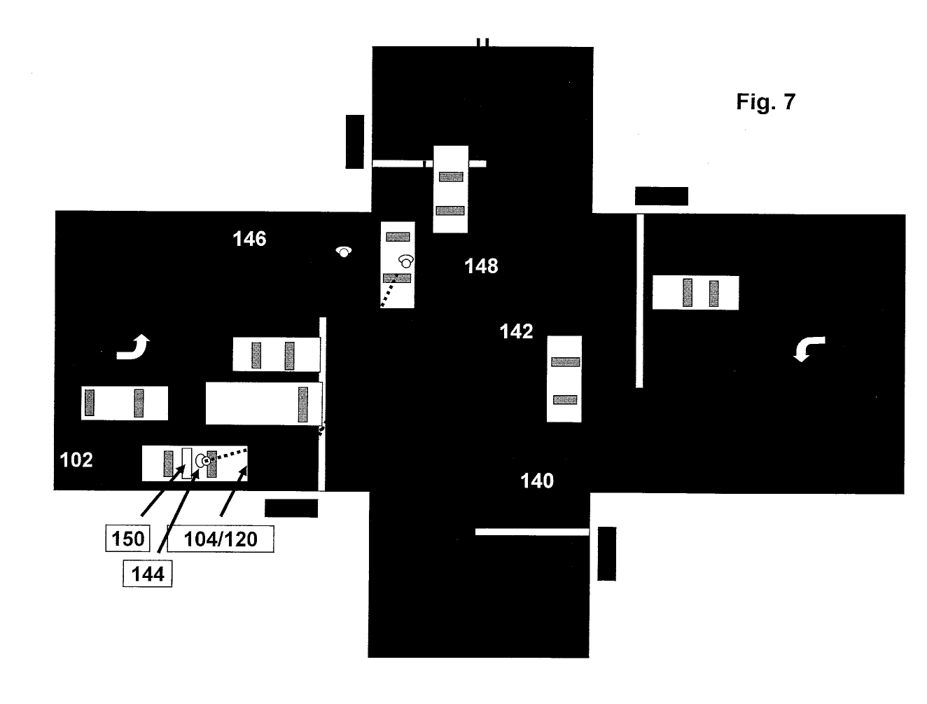

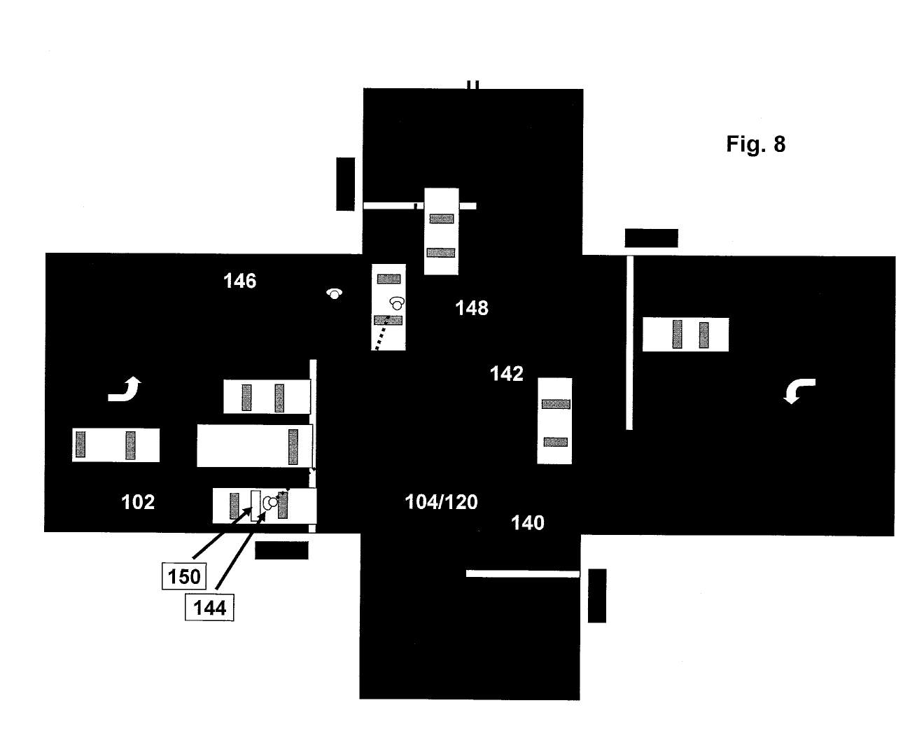

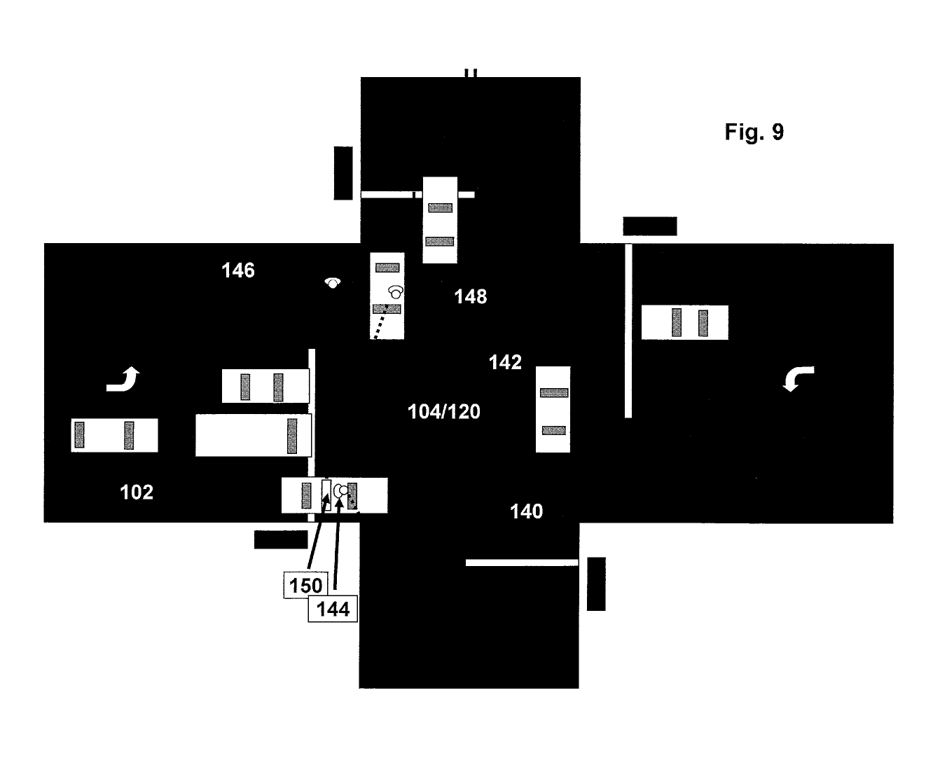

As can be seen in FIGS. 7, 8 and 9, the present invention permits an emergency response vehicle 102 travelling down a first road 140 towards and into a second intersecting cross road 142 to more safely breach the intersection. FIGS. 7, 8 and 9 show the lines of sight of the driver 144 of the emergency response vehicle 102, a pedestrian 146, and a cross-street motorist 148. Turning now to FIG. 8, where the present invention has been installed on the emergency response vehicle 102, the license plate frame 104 and LED lights 120 enter the line of sight of the pedestrian 146 and cross-street motorist 148 before the body of the emergency response driver 144 or roof-mounted emergency response lights 150 enter the intersection. Turning now to FIG. 9, where the present invention has been installed on the emergency response vehicle 102, by the time the body of the emergency response driver 144 or the roof-mounted emergency response lights 150 enter the intersection, the present invention had previously alerted the pedestrian 146 and cross-street motorist 148 of the emergency response vehicle 102 entering the intersection.

Where the light display is situated in front of the bumper and is lit or lightable to emit light, that light is visible from a vantage point on each side of the vehicle laterally ahead of the front surface of the bumper. As used herein, laterally ahead of the front surface of the bumper is defined by a location some distance away from and ahead of the vehicle and not within the direction of forward travel of the vehicle.

The license plate frame 104 of the present invention may be a license plate holder custom manufactured to accept or have integrated therein warning lights 120 and related wiring 130 and hardware, or the license plate holder may be a standard unit that has been retrofitted to accept warning lights and related wiring and hardware.

The housing 114 may be manufactured by any manner known to those of ordinary skill in the art, including injection molding of a thermoplastic material. Preferably, as opposed to many license plate frames or holders in the art that can be flimsy and made of a thin material, the license plate frame of the present invention preferably is rigid, durable, and dense. This preferred strength provides a reliable housing on which the LED lights are mounted, and may also provide a measurable degree of impact protection for the LED lights and related wiring during low to moderate speed front end collisions.

In a preferred embodiment, the present invention may be mounted on the front bumper of an emergency response vehicle 102 in a typical manner that is consistent with many manufacturers' standard license plate holder installation procedure.

In sum, in a particularly preferred embodiment, the present invention is an assembly comprising a license plate holder and at least two LEDs, wherein the license plate holder comprises a back, a front, a top, a bottom, and left and right sides, where the back, the front, the top, the bottom, and the left and right sides define a housing, where the front further comprising a mechanism by which a license plate may be affixed thereto and the license plate holder secured to the vehicle, and where the left and right sides each further comprising at least one light orifice, and where the housing is an at least partially concave cavity, and wherein each LED comprises a lighthead, each lighthead comprising a lens and one or more bulbs, and wherein each LED is mounted within a light orifice such that the lens and one or more bulbs is positioned to emit light outwardly from the housing, and wherein the license plate holder assembly further comprises wiring for operatively connecting each LED to an emergency response vehicle, the wiring substantially contained within the housing, and wherein the assembly may be configured to permit either protruding or flush mounting of the lenses relative to the side walls of the housing.

Additionally, the present invention includes a method of operating an automotive vehicle, preferably an emergency response vehicle that has been equipped with the license plate holder assembly previously detailed herein, the method comprising at least the steps of an operator, preferably an emergency responder, driving the emergency response vehicle and the emergency responder activating the light display.

Benefits associated with the present invention include meeting the need of public safety agencies, particularly law enforcement, by simply and affordably equipping the frontal most portions of emergency vehicles with ample warning power to improve safe passage through traffic intersections, including those that are congested or otherwise treacherous, during emergency operation.

The present invention is of great utility in that potentially all city, county, state, and federal law enforcement agencies that operate standard emergency motor vehicles could benefit from the added safety associated with the invention. The present invention's discrete and low profile characteristics permit installation on both covert and overt emergency vehicles.

All references, including without limitation all papers, publications, presentations, texts, reports, manuscripts, brochures, internet postings, journal articles, periodicals, and the like, cited in this specification are hereby incorporated by reference. The discussion of the references herein is intended merely to summarize the assertions made by their authors and no admission is made that any reference constitutes prior art. The inventors reserve the right to challenge the accuracy and pertinence of the cited references.

In view of the above, it will be seen that the several advantages of the invention are achieved and other advantageous results obtained. It should be understood that the aforementioned embodiments are for exemplary purposes only and are merely illustrative of the many possible specific embodiments that can represent applications of the principles of the invention. Thus, as various changes could be made in the above methods and compositions without departing from the scope of the invention, it is intended that all matter contained in the above description as shown in the accompanying drawings shall be interpreted as illustrative and not in a limiting sense. Moreover, one of ordinary skill in the art can make various changes and modifications to the invention to adapt it to various usages and conditions, including those not specifically laid out herein, without departing from the spirit and scope of this invention. Accordingly, those changes and modifications are properly, equitably, and intended to be, within the full range of equivalents of the invention disclosed and described herein.

I claim:

1. An attention-attracting device comprising a frame for a license plate, the frame being configured for mounting on a front surface of a front bumper of an automotive vehicle having a front and back and two sides, and a light display on, in, or extending from the frame such that, when the frame is mounted on the bumper, the light display is situated in front of the bumper and is lit or lightable to emit light that is visible from a vantage point on each side of the vehicle laterally ahead of the front surface.

2. A device as set forth in claim 1 wherein the frame comprises left and right sides spaced horizontally apart from each other so as to be able to straddle a license plate therebetween, the light display comprising at least one light on, in or extending from the left side of the frame and at least one light on, in or extending from the right side of the frame.

3. The device as set forth in claim 2 wherein the frame further comprises a housing, the housing is an at least partially concave cavity defined by the left side and the right side of the frame, the left side and right side each further comprising at least one light orifice, and wherein the light display comprises light emitting diodes, and each light emitting diode is mounted within a light orifice.

4. The device as set forth in claim 3 further comprising wiring for operatively connecting each light emitting diode to an automotive vehicle on which the device is mounted, the wiring substantially contained within the housing.

5. The device as set forth in claim 4 wherein the wiring of the light emitting diodes is combined into one fused circuit, the fused circuit comprising a fuse.

6. The device as set forth in claim 3 wherein the frame is a license plate holder between 5″ to 10″ in height, between 10″ to 16″ in width, and between 2″ to 3½″ in depth.

7. The device as set forth in claim 1 wherein the device has been operatively mounted on the front bumper of an emergency response vehicle.

8. The device as set forth in claim 3 wherein each light emitting diode has been mounted on the frame in an external mount configuration.

9. The device as set forth in claim 3 further comprising at least one spacer, wherein each light emitting diode has been mounted on the frame in an external mount configuration.

10. An automotive vehicle comprising front and back ends and two sides, the front end being a front bumper having a front surface, and a light display located in front of the front bumper, the light display being lit or lightable to emit light that is visible from a vantage point on each side of the vehicle laterally ahead of the front surface.

11. An automotive vehicle as set forth in claim 10 wherein the light display is on, in or extends from a license plate frame mounted on the front surface of the front bumper.

12. An automotive vehicle as set forth in claim 11 wherein the frame comprises left and right sides spaced horizontally apart from each other so as to be able to straddle a license plate therebetween, the light display comprising at least one light on, in or extending from the left side of the frame and at least one light on, in or extending from the right side of the frame.

13. Additionally, the present invention includes a method of operating an automotive vehicle, comprising the steps of providing an automotive vehicle comprising front and back ends and two sides, the front end being a front bumper having a front surface, and a light display located in front of the front bumper, the light display being lit or lightable to emit light that is visible from a vantage point on each side of the vehicle laterally ahead of the front surface; an operator driving the automotive vehicle; and the driver activating light display.
